(19) United States
(12) Patent Application Publication
(10) Pub. No.: US 2010/0031566 A1
(43) Pub. Date: Feb. 11, 2010

(54) Automatic Micro-Garden Apparatus

(76) Inventor: Sidney S. Azoulay, Pahrump, NV (US)

Correspondence Address: FRANK J. MCGUE, 10801 N. 32ND STREET SUITE 5, PHOENIX, AZ, 85028, US

(21) Appl. No.: 12/432,165

(22) Filed: Apr. 29, 2009

Related U.S. Application Data
(63) Continuation-in-part of application No. 11/655,523, filed on Jan. 19, 2007, now abandoned.
Application No. 11/655,523 is a continuation-in-part of application No. 11/490,919, filed on Jul. 21, 2006.
(60) Provisional application No. 60/701,291, filed on Jul. 21, 2005.

(51) Int. Cl. A01G 31/00

(52) U.S. Cl. 47/61; 47/60

(57) ABSTRACT

An automatic garden apparatus comprises a container having a lower portion adapted to hold liquids, a pocket portion and a tray portion mounted atop the lower portion. The pocket portion forms an enclosed structure having a plurality of pockets, a mist generator and a mist opening therethrough. The plurality of pockets and the mist generator are positioned on the top surface of the pocket portion. The plurality of pockets are adapted for insertion of plants and cutting and seeds. The tray portion includes a plurality of shallow trays whose bottoms are positioned to contact the liquids, the tray portion facing the mist opening whereby mist from the mist generator keeps moist the trays. An electronic circuit informs the user when to add water and nutrients, and includes a timer to controls operation of the mist generator to keep a high moist environment inside the plant portion.

### RELATED APPLICATIONS

This application is a continuation-in-part of co-pending application Ser. No. 11/655,523 filed Jan. 19, 2007 which is a continuation of application Ser. No. 60/701,291 filed Jul. 21, 2005. This application is a continuation-in-part of co-pending application Ser. No. 11/490,919 filed Jul. 21, 2006 which is a continuation of application Ser. No. 60/701,291 filed Jul. 21, 2005.

### TECHNICAL FIELD

This invention relates to equipment for automatically sprouting or germinating seeds, growing plants and, more particularly, to a garden machine which automatically feeds and waters plants, sprouts and germinates seeds in a home.

### BACKGROUND OF THE INVENTION

Sprouts and greens are known to be powerfully nutritious foods yet are often forgotten on the food pyramid. The nutritional value of vegetables and sprouts is well established by both nutritionists and by the scientific community. This knowledge has resulted in an increased popularity for sprouts and greens as foods which, in turn, has resulted in a need to have sprouts readily available to a consumer. The term “greens” relates to vegetables such as lettuce, tomatoes, green peppers and the like.

Presently most sprouts and vegetables are grown in factories or farms and transported thousands of miles in refrigerated trucks to their destination. The conventional method of providing such foods to the marketplace requires shipping and storage before the products reach the consumer. Furthermore, vegetables and sprouts are very delicate crops and refrigeration should be avoided as freshness is ultimate when consuming the sprouts and vegetables exactly when ready.

Additionally, experts claim that the most effective time to consume sprouts, for example, for its nutritional benefits is around the 5′ day of germination, sprouted bean seeds around the 48 hours from commencement of germination. Further, another problem with existing vegetable and sprout operations is outbreaks of food borne illnesses such as salmonella or e. coli reported to the Food and Drug Administration.

Thus, there is a need for an apparatus to provide fresh sprouts and vegetables for home use. Their have been some attempts to provide such an apparatus. U.S. Published Application US2006/02722210 entitled “Smart Garden Devices and Methods for Growing Plants” filed by Bissonnette et al. and published on Dec. 7, 2006 shows a device having a timer to remind users to feed and water plants contained therein.

U.S. Pat. No. 6,442,892 entitled “Automatic Sprouter System” which issued on Sep. 3, 2002 to the present inventor, and is commonly owned by the applicant of the present application, provides a misting and oxygenating automatic sprouter system.

U.S. Pat. No. 4,144,671 entitled “Apparatus for Growing Bean Sprouts” which issued on May 20, 1979 to Lee discloses a self watering apparatus including a housing divided into an upper and a lower compartment by a horizontal divider plate having orifices therethrough. A tilting water container is used to periodically supply water to plants in the upper compartment.

U.S. Pat. No. 4,989,367 entitled “Method and Apparatus for Germinating Seed Sprouts” which issued on Feb. 5, 1991 to Chung discloses accelerated sprouting of bean sprouts by placing said sprouts in a closed vessel on a screen. The seeds are soaked with water and additives and humidified air is blown through at periodic intervals.

U.S. Pat. No. 5,025,589 entitled “Methods and Apparatus for Growing Bean Sprouts” which issued on Jun. 25, 1991 to Park discloses a series of vertical beds having bean sprouts growing therein organized in order of size with the largest at the top. Water cascades downward through the beds at periodic intervals.

However, there is still a need for a apparatus for use by the home owner or small commercial concern which is fully automatic and safely provides fresh sprouts and greens to a consumer with minimal human touch. The present invention meets these needs.

None of the known prior art disclose the device set forth herein.

### SUMMARY OF THE INVENTION

It is an object of this invention to provide a fully automatic vegetable and sprout growing vending machine.

It is another object of this invention to supply a micro environment which is optimal for sprouting and growing greens.

It is a further object of this invention to provide a combination of a hydroponic grower, cloner, germinator of seeds and grower of sprouts in one apparatus.

Further objects and advantages of the invention will become apparent as the following description proceeds and the features of novelty which characterize this invention will be pointed out with particularity in the claims annexed to and forming a part of this specification.

### BRIEF DESCRIPTION OF THE DRAWINGS

The present invention may be more readily described by reference to the accompanying drawings in which:

FIG. 1 is a front and side perspective view of one embodiment of the present invention;

FIG. 2 is a close up perspective view of a base of the embodiment of FIG. 1;

FIG. 3 is a top and front perspective view of a variant embodiment of the base of the present invention;

FIG. 4 is a top view of the still another embodiment of the base of the present invention;

FIG. 5 is a cross sectional side view of another embodiment of the present invention;

FIG. 6 is a cross sectional side view of a misting apparatus used in the present invention;

FIG. 7 is close up cross sectional view of the upper portion of the misting apparatus of FIG. 6;

FIG. 8 is a close up view of a tapered shaft and disk used on the present invention.

### DESCRIPTION OF THE PREFERRED EMBODIMENT

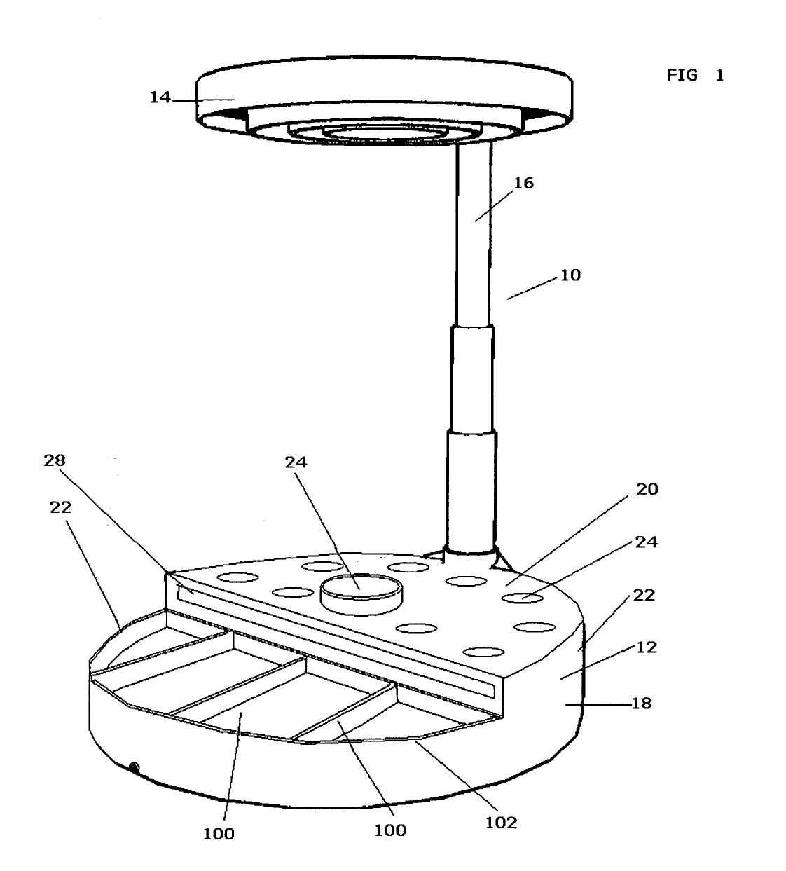

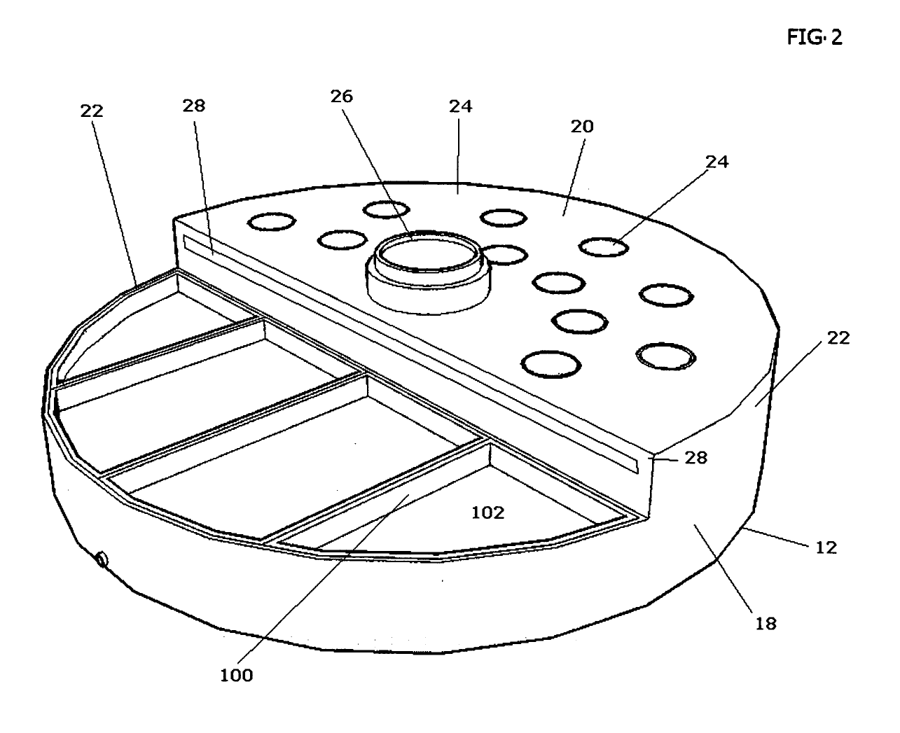

Referring more particularly to the drawings by characters of reference, FIGS. 1-2 disclose one embodiment of an automatic garden apparatus 10. Automatic garden apparatus 10 comprises a container 12, an overhead light 14 connected to container 12 by a telescopic stand 16.

Container 12 includes a lower portion 18 which is adapted to hold liquids. Mounted atop lower portion 18 are a pocket portion 20 and a tray portion 22. Pocket portion 20 extends upwardly from lower portion 18 form a generally enclosed structure 19 except for a plurality of pockets 24, a mist generator 26 and a mist opening 28. Pockets 24 and mist generator 26 are positioned the top surface of pocket portion 20 while mist opening 28 faces tray portion 22.

Plurality of pockets 24 are provided for inserting plants or cuttings or seeds 23. Pockets 24 are covered with caps 25 if not in use. Use of pockets 24 allows a user to simply lift said net pockets to move of plants from one apparatus 10 to another without having transplant shock.

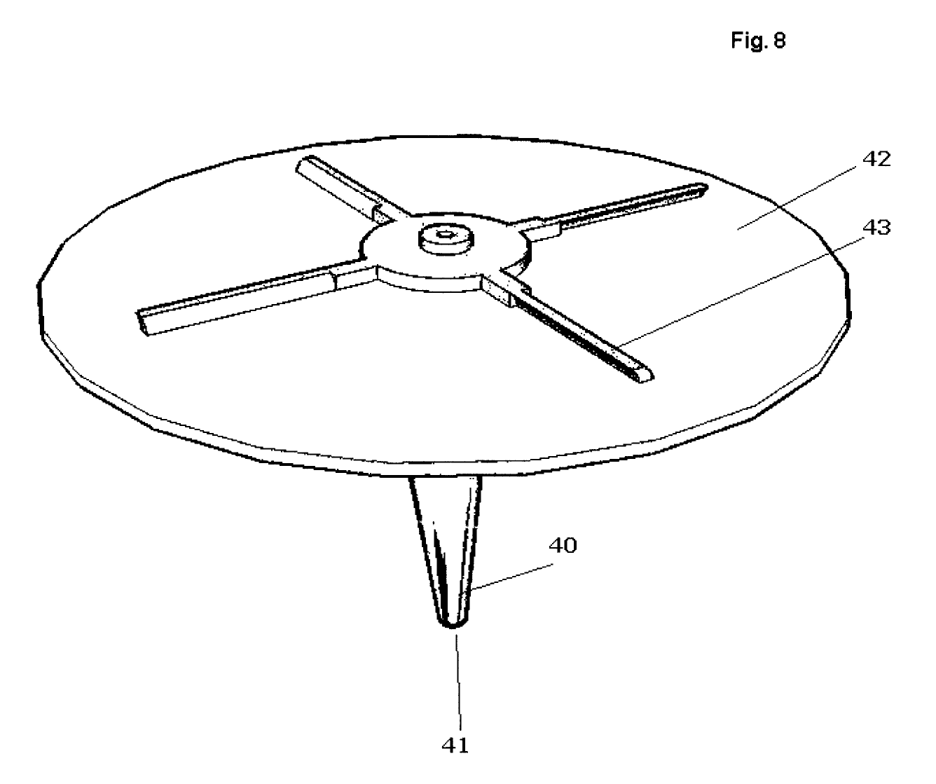

The heart of the system is mist generator 26. Turning now to FIGS. 5-8, pocket portion 20 includes mist generator 26. Mist generator 26 includes a motor 38 which is mounted in a motor compartment 31 and has a hollow tapered shaft 40 extending downwardly therefrom. Best seen in FIG. 8 is a hollow tapered shaft 40, open at both its upper and lower ends, which extends downwardly from motor 38 and into water 33. Shaft 40 is tapered from a wide portion at the top to a narrower portion below. When shaft 40 is spinning rapidly, the combination of centripetal force on the water and the outwardly sloping inner surface of tapered shaft 40 forces water upwardly therein as shown by arrows 41. The amount of water 33 lifted by shaft 40 is dependent upon the diameter and length of shaft 40 and the rotational speed thereof.

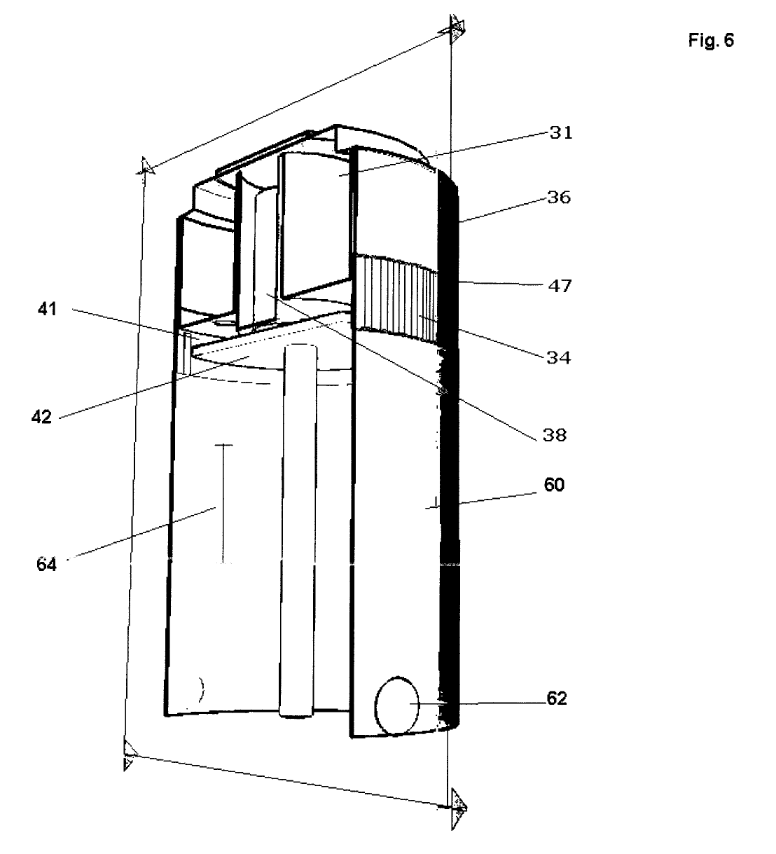

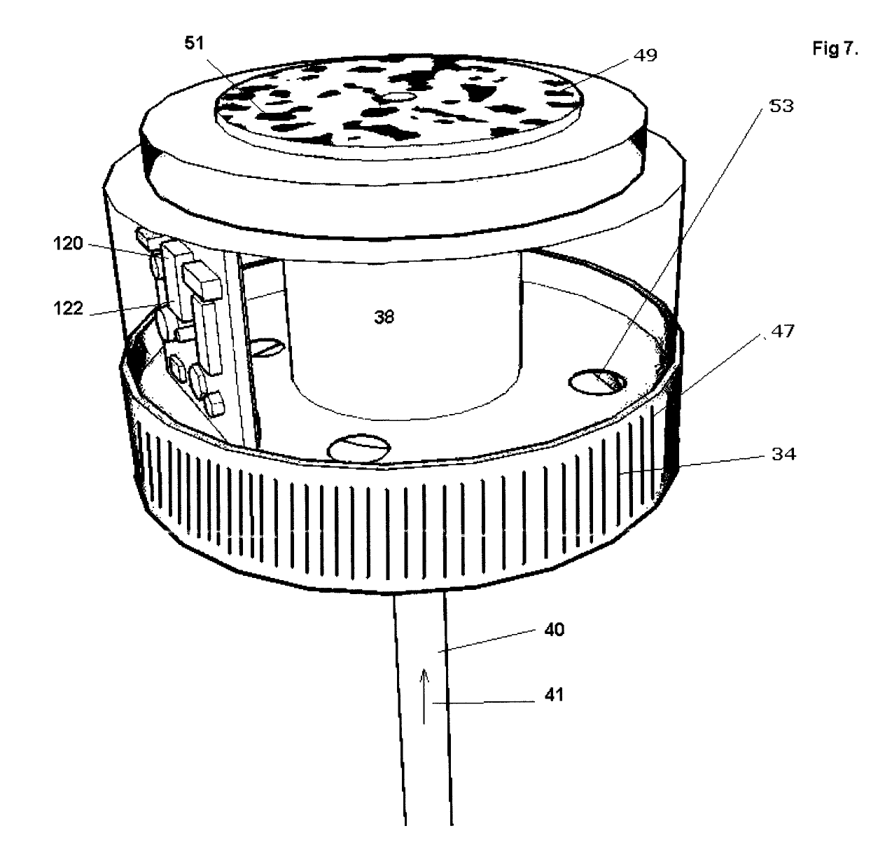

In one variant best seen in FIGS. 5 and 7, shaft 40 extends downwardly into water 33. In another variant best seen in FIG. 6, shaft 40 has a cylindrical housing 60 extending around with water intake holes 62 extending therethrough to allow water to enter same. A water level sensor 64 is provided to control the amount of water in the apparatus.

Mounted atop the open upper end of shaft 40 is a disk 42. The open upper end of shaft 40 directs water 33 onto disk 42 as shown by arrows 41. The spinning disk 42 includes radially oriented blades 43 which impel the water off in a radial movement in small droplets. These small droplets encounter a mesh cage 47 which comprises a plurality of fins 34 mounted proximate to the periphery of disk 42. In addition, spinning disk 42 creates a low pressure area which pulls air into mixing area 34 through air filter 49 as shown arrows 51 and then through air intakes 53. The incoming air 51 and water 41 are thoroughly mixed within mixing area 34 which is thereafter forced through mesh 47 to plant compartment 14 in a fine mist. The fineness of the mist particles is dependent upon the separation between fins 34 as well as the rotational speed of disk 42.

In addition, as best seen in FIGS. 5 and 6, mesh 47 is freely rotatable. The outward air flow encountering rudder 51 from rapidly spinning disk 42 causes mesh 47 to rotate slowly about the periphery of disk 42.

The action of mist generator 26 provides for an increase in air pressure within plant compartment 14 when operating. The pressurization acts to oxygenate water 33 and provides more air (oxygen) and water to the cloned plants. This also results in a coolant effect to offset the heat generated by the plant growth itself. The excess air pressure bleeds out through porous net pockets 20. In addition, rotating shaft 40 itself creates constant ripples in the water 41 adding oxygen thereto.

Tray portion 22 includes a plurality of shallow trays 100 whose bottoms 102 are positioned to contact water 33. In addition, facing tray portion 22 is mist opening 28 which allows mist from mist generator 26 to keep moist seeds in trays 100.

Apparatus 10 is fully automatic. An electronic circuit 120 informs the user when to]add water and nutrition. A built in timer switch 122 ON and OFF controls mist generator 26 to keep a high moist environment inside plant portion 20. A build in timer switch on hydroponic growing lights 14 ON and OFF. This is in order to compensate for the environmental climate conditions which differ from place to place and season to season. The fresh air introduced into apparatus 10 is filtered thru air filter 49 to minimize introduction of foreign matter into the growing compartment. Vegetables and herbs can be grown in the top section and sprouts and greens in the side pocket thus growing a complete salad at home is possible.

In one variant, cartridges 130 are seeded with a variety of seeds fixed to the bottom thereof. Cartridges 130 are packed and shipped to the customer ready to plant. The user adds disposable cartridges 130 in the trays 100 space allocated for it. Such cartridges 130 with a variety of seeds for sprouting can be shipped on a periodic basis regularly to the customer according to his/her pre-order. The use of cartridges 130 offers convenience, increase hygiene and minimize the risk of contamination.

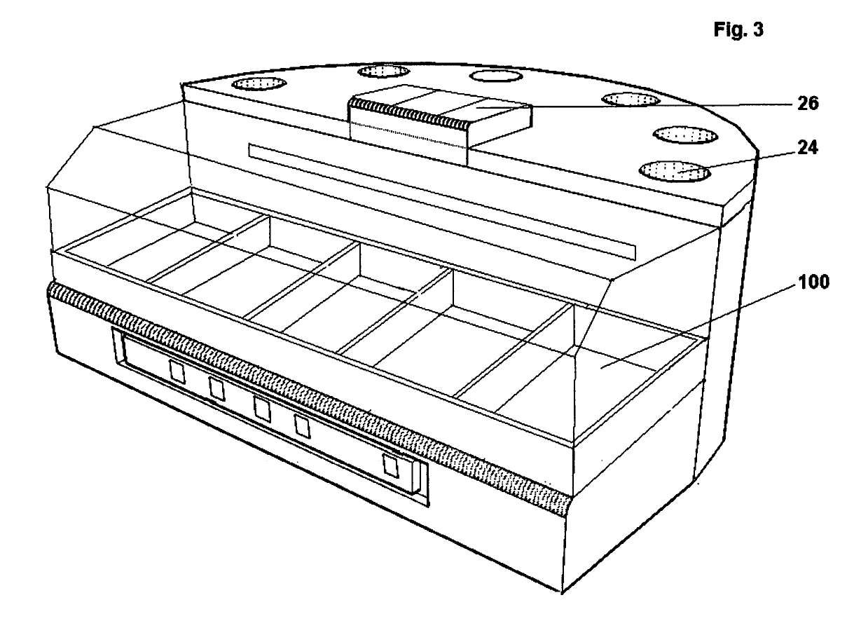

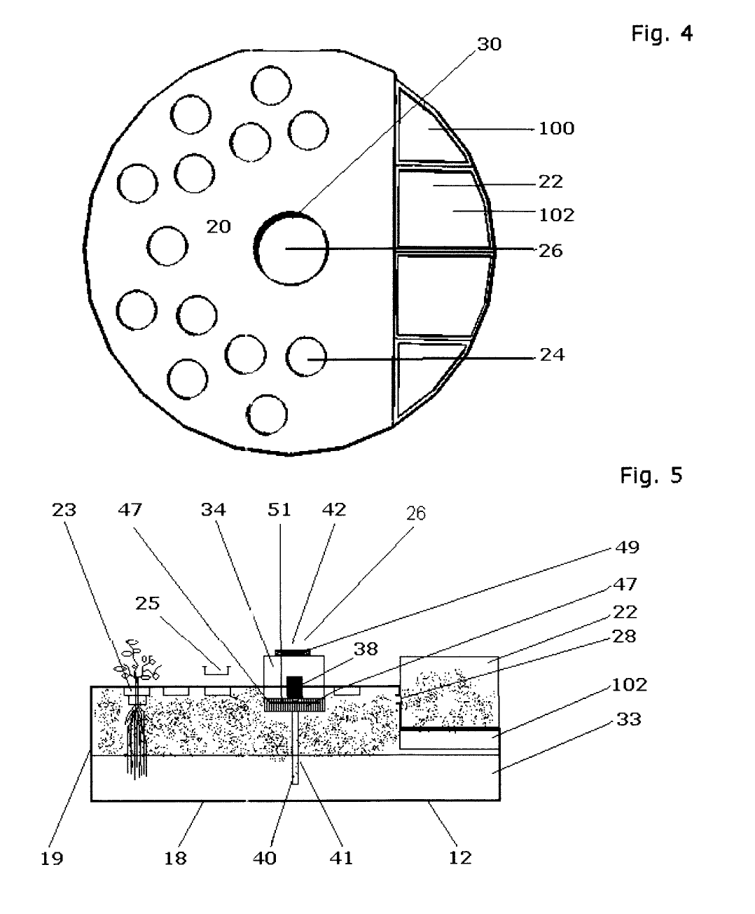

The variant with cartridges 130 is best used with the embodiment of FIG. 3 wherein tray portion 22 is rectangular whereby each tray 100 is the same size.

Although only certain embodiments have been illustrated and described, it will be apparent to those skilled in the art that various changes and modifications may be made therein without departing from the spirit of the invention or from the scope of the appended claims.

That which is claimed is:

1. An automatic garden apparatus comprises:
a container having a lower portion adapted to hold liquids, a pocket portion and a tray portion mounted atop the lower portion,
the pocket portion forming an enclosed structure having a plurality of pockets, a mist generator and a mist opening therethrough, the plurality of pockets and the mist generator being positioned on the top surface of the pocket portion, the plurality of pockets adapted for insertion of plants and cutting and seeds,
the tray portion including a plurality of shallow trays whose bottoms 102 are positioned to contact the liquids, the tray portion facing the mist opening whereby mist from the mist generator keeps moist the trays, and
an electronic circuit which informs the user when to add water and nutrients, and includes a timer to controls operation of the mist generator to keep a high moist environment inside the plant portion.

2. The automatic garden apparatus of claim 1 further comprising an overhead light.

3. The automatic garden apparatus of claim 2 wherein the overhead light is connected to the container by a stand.

4. The automatic garden apparatus of claim 3 wherein the stand is a telescopic stand.

5. The automatic garden apparatus of claim 2 wherein the overhead light is operatively connected to a timer which turns the overhead light on and off on a predetermined schedule.

6. The automatic garden apparatus of claim 1 further comprising caps adapted to cover each of the plurality of pockets when the pockets are not in use.

7. The automatic garden apparatus of claim 1 wherein the mist generator comprises a motor having a hollow tapered power shaft extending downwardly therefrom into the water, the hollow tapered power shaft having a wide portion at the top and a narrow portion at the bottom thereof whereby when the hollow tapered power shaft is rotation, the combination of centripetal force on the water in the hollow tapered power shaft and the outwardly sloping inner surface thereof forces water upwardly therein,
a disk mounted atop the hollow tapered power shaft and extending laterally therefrom which receives water from the hollow tapered power shaft and directs the water laterally therefrom, the amount of water lifted by the hollow tapered power shaft being dependent upon the diameter and length of the hollow tapered power shaft and the rotational speed thereof, and
a mesh cage surrounding the disk whereby water from the disk is forced therethrough in a fine mist.

8. The automatic garden apparatus of claim 7 wherein the disk includes one or more radially oriented blades which create a low pressure mixing area above the disk to thereby pull fresh air via suction into the mixing area above the disk, the air and the water mixing to provide the fine mist.

9. The automatic garden apparatus of claim 7 wherein the mesh cage comprises a plurality of fins mounted proximate to the periphery of an annulus mounted proximate to the edge of the disk.

10. The automatic garden apparatus of claim 9 wherein the fineness of the mist is predetermined by the separation between each of the plurality of the fins and the rotational speed of the disk.

11. The automatic garden apparatus of claim 7 wherein the mesh cage is freely rotatable.

12. The automatic garden apparatus of claim 11 wherein the mesh cage further includes a rudder extending outwardly therefrom, the fine mist encountering the rudder thereby causing the mesh cage to rotate.

13. The automatic garden apparatus of claim 1 further comprising one or more cartridges having seeds affixed to the bottom thereof, the one or more cartridges adapted to mount in the trays.
